(19) United States
(12) Patent Application Publication
(10) Pub. No.: US 2006/0121905 A1
(43) Pub. Date: Jun. 8, 2006

(54) Communication unit, communication system and method for reducing network congestion therein

(76) Inventors: Paul McDonald, Swindon (GB); Martin Ellis, Ipswich (GB)

Correspondence Address: MOTOROLA, INC., 1303 EAST ALGONQUIN ROAD, IL01/3RD, SCHAUMBURG, IL, 60196, US

(21) Appl. No.: 10/541,332

(22) PCT Filed: Feb. 24, 2004
(86) PCT No.: PCT/EP04/50197

§ 371 Date: Jun. 29, 2005

(30) Foreign Application Priority Data
Mar. 28, 2003 (GB) 0307151.1

(51) Int. Cl. H04Q 7/20

(52) U.S. Cl. 455/445

(57) ABSTRACT

A wireless communication system (500) provides a number of communication resources for a plurality of mobile stations (512-516). The wireless communication system employs a call gapping process and comprises a number of communication paths for routing a communication initiated by one of the plurality of mobile stations (512-516) to a destination node. One or more of the plurality of mobile stations (512-516) is configured to perform the call gapping process. A communication unit and a method of congestion relief are also provided. The proposed technique provides congestion relief using call gapping, extended to use by a wireless subscriber unit to minimise air-interface traffic in a wireless communication environment. In this manner, calls are prevented from being initiated when they would have ultimately resulted in an unconnected call.

### FIELD OF THE INVENTION

This invention relates to a mechanism for reducing network congestion in a communication system. The invention is applicable to, but not limited to, a mechanism for wireless subscriber units to self regulate their operation in order to reduce network congestion in a cellular communication system.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs).

In a wireless communication system, each BTS has associated with it a particular geographical coverage area. Transmitter power levels and receiver sensitivity performance define the coverage area where the BTS can maintain acceptable communications with MSs. Typically, coverage areas are configured as overlapping areas to facilitate continuous communication as MS move between the areas. The coverage areas are generally termed cells, which can combine to produce an extensive coverage area of the communication system, for example to provide countrywide coverage.

Wireless communication systems are distinguished over fixed communication systems, such as the public switched telephone network (PSTN), principally in that mobile stations move between coverage areas served by different BTS (and/or different service providers) and, in doing so, encounter varying radio propagation environments. Therefore, in a wireless communication system, MSs perform handover operations, when moving between different geographical areas/cells. In this manner, the MSs can be supported in their communications by the nearest BTS, which typically offers the highest quality signal/communication link. Each BTS is connected to a Base Site Controller (BSC), which together form a Base Switching Site (BSS).

An established harmonised cellular radio communication system, providing predominantly speech and short data messaging communication, is the Global System for Mobile Communications (GSM). An enhancement to this cellular technology has been developed, termed the General Packet Radio System (GPRS). GPRS provides packet switched technology on GSM's switched-circuit cellular platform.

A fixed network interconnects all BTSs, through respective BSCs. This fixed network comprises communication lines, switches, interfaces to other communication networks and various controllers required for operating the network. A call from a MS is routed through the fixed network to the destination node or communication unit identified by the call. If the call is between two MSs of the same communication system she call will be routed through the fixed network to the BTS of the cell in which the other MS is currently located.

A connection is thus established between the two serving cells through the fixed network. Alternatively, if the call is between a MS and a telephone connected to the Public Switched Telephone Network (PSTN) the call is routed from the serving BTS to the interface between the cellular mobile communication system and the PSTN. It is then routed from the interface to the telephone by the PSTN.

In the field of communication systems, it is known that particular events can place a telecommunication system under increased network load, causing failure of communication links. For example, it is known that ‘events’ such as faults, emergencies, advertising campaigns, televised telephone hotlines, etc., can result in a large number of call attempts to a particular number or set of numbers, which increases network load.

This scenario is illustrated in the wireless communication system 100 of FIG. 1. A number of wireless subscriber units 110 attempt to contact a particular telephone number, for example telephone number ‘X’ 160. Hence, the air-interface resource is heavily utilised to carry the wireless transmissions 115 to the subscriber unit's respective BSSs 120. The fixed network connections 125 between the wireless BTSs and the wireless exchange 130 also become heavily loaded. All of these calls are then routed through the core network 140 to a destination exchange 150. Generally, a limited number of telephone lines are utilised by destination unit ‘X’ 160 to receive these calls from the destination exchange 150. Therefore, a vast number of the incoming calls take up valuable resources, but are ultimately rejected by the destination exchange 150.

It is known, in extreme circumstances, that the target telephone exchange 150 may fail under the load of refusing a large number of incoming call attempts. This is a serious problem and network operators maintain staff to take preventative action on such occurrences.

A known technique commonly used to solve this problem in fixed communication networks is termed “call gapping”. A second known technique is “code blocking”. A “Code-blocking” technique blocks a percentage of calls that are routed to a specific destination code/address. In most cases, a code-block control can also be specified to include the called station's address.

On the other hand, call-gapping control, like code-block control, limits routing to a specific code or station address. Call gapping consists of an adjustable timer that stops all calls to a specified code for a time interval selected from, say, sixteen different time intervals. After the expiration of the time interval, one call to the specified code or address is allowed access to the network, after which the call-gapping procedure is re-initiated for another time interval. It is known that call gapping is more effective than the code-block control in controlling mass calling situations.

A conceptual diagram. 200 in FIG. 2 illustrates the concepts of call gapping. Call gapping involves automatically rejecting a percentage of the incoming call attempts. The rejection process is arranged at the ingress telephone exchange 230 to the core network 140, to avoid route congestion. Since these automatically failed calls never access the overloaded destination point 150 in the core network 140, the signalling load at this point, and through the core network 140, is reduced.

Typically, when a particular destination point 150 is experiencing, or is anticipated to experience, an excessive amount of call attempts, then call gapping is activated for that number in all telephone exchanges 130. The process for setting up, and modifying, a call gapping operational status is illustrated in the flowchart 300 of FIG. 3.

An Operations and Management Centre (OMC) of the wireless communication system makes a determination as to how, and under what conditions, to invoke call gapping. Starting from an idle status, in step 310, the OMC (or an Operator) is informed (or recognises) that an overloaded/congested network condition exists at a particular network node ‘A’. In response to this, the OMC invokes a call gapping process, as shown in step 320. The OMC then sends a message to all communication exchange functions (routers, gateways, etc.) to initiate call gapping at their particular node. The call gapping is applied for ‘X %’ of calls received at the communication exchange functions and addressed to a particular number or set of numbers, as shown in step 330. The OMC then returns to an idle mode, in step 360, until the ‘event’ has finished.

Call gapping therefore causes a number of the originating telephone exchanges to automatically fail ‘X’ out of ‘Y’ calls made to that destination number. Thus, only (Y-X) out of ‘Y’ calls actually leave the originating exchange and make it to the destination exchange.

In a similar manner, the OMC (or Operator) modifies the call gapping process when it recognises, or is informed, that the overload/congestion situation no longer exists, in step 340. When this happens, the OMC sends a message to all of the exchanges to modify their call gapping processes for destination node ‘A’, in step 350, and returns to an idle mode of operation, in step 360.

The operation at the exchange is illustrated in the flowchart 400 of FIG. 4. In this regard, the exchange is woken up from an idle mode of operation in step 405, in one of the following three ways. The exchange receives a message from the OMC to invoke call gapping to a destination node, a particular telephone number or a set of numbers and block ‘X %’ of calls, in step 410. The exchange will then update its call gapping list for the destination node(s)/number(s) with the rule to block ‘X %’ of calls, in step 415. The exchange will then return to an idle mode of operation, whilst performing call gapping, in step 455.

Following the exchange invoking a call gapping mode of operation, the exchange may be woken from an idle mode of operation, in step 405, when it receives a call attempt to the partially blocked destination node ‘A’, as shown in step 430. It the exchange determines that the intended destination of the call is not in the call gapping list in the normal manner, as shown in step 435, the exchange sets up the call in step 445 and returns to an idle mode of operation in step 455. If, however, the exchange determines that the intended destination of the call is in the call gapping list in step 435, the exchange will, for example, invoke call gapping. In this regard, call gapping allows one connection request for a controlled code or set of code's to be accepted into the network, by each-node. This connection is allowed once every ‘x’ seconds. Any connection requests arriving after the accepted connection request are rejected for the next ‘y’ seconds. In this manner, call gapping effectively limits the number of successful connection requests and prevents the overload of the network to a particular focal point, as shown in step 440.

If the exchange determines that the value of the random number generated is above the requested blocking percentage value, the exchange sets up the call to destination ‘A’ in step 445 and returns to an idle mode of operation in step 455. If, however, the exchange determines that the value of the random number generated is at or below the requested blocking percentage value, the exchange does not set up the call-to destination ‘A’ in step 445. The exchange then returns a “network busy” message to the originating caller and returns itself to an idle mode of operation in step 455.

Thus, call gapping is effective for a fixed network. However, a call gapping technique is much less effective when utilised in a mobile network employing a shared air-interface, such as a GSM cellular communication system.

U.S. Pat. No. 5,548,533, titled “Overload control for a central processor in the switching network of a mobile communications system”, describes a network overload control mechanism for a central processor in a switching network of a mobile radio system. The central processor may be part of a Mobile Switching Centre (MSC). In U.S. Pat. No. 5,548,533, congestion reports that are based on the delay experienced by messages waiting processing at the central processor are broadcast to peripheral processors. The peripheral processors are located in the MSC at interfaces of the MSC to other network elements such as base transceiver stations (BTSs), the PSTN, or other MSCs. Therefore, the MSC is configured to reject a number of call attempts received from wireless subscriber units.

However, a large amount of call attempts from mobile users, which effectively have little or no chance of success, still consume valuable and scarce radio resource. In particular, extraordinary events, for example road accidents, can cause excessive mobile calls being made in a particular area, which creates communication problems for all mobile users in that area.

Thus, there exists a need in the field of the present invention to provide a communication system and a method for congestion relief in network overload situations, wherein the aforementioned disadvantages may be alleviated.

### STATEMENT OF INVENTION

In accordance with a first aspect of the present invention, there is provided a wireless communication system, as claimed in claim 1.

In accordance with a second aspect of the present invention, there is provided a communication unit, as claimed in claim 8.

In accordance with a third aspect of the present invention, there is provided a method of congestion relief, as claimed in claim 13.

In accordance with a fourth aspect of the present invention, there is provided a storage medium, as claimed in claim 18.

In summary, the inventive concepts of the present invention alleviate the problems associated with prior art by moving the call gapping mechanism down into the wireless subscriber units, to minimise wasted use of the air-interface as well as communication links from serving communication units to originating exchanges.

Hence, moving the call gapping function into the wireless subscriber units prevents the calls, which cannot be handled by the destination node or exchange, from ever being originated. This prevents wasteful congestion on any parts of the network. Preferably, the call gapping parameters are broadcast to cell sites to communicate thereon to all subscriber units.

### BRIEF DESCRIPTION OF THE DRAWINGS

FIG. 1 shows a conceptual diagram of a cellular radio communications system indicating a large number of calls being routed to an overloaded destination node/number;

FIG. 2 shows a conceptual diagram of a cellular radio communications system indicating a large number of calls being routed to an overloaded destination node/number, when call gapping is employed;

FIG. 3 illustrates a flowchart of a call gapping mechanism for an OMC; and

FIG. 4 illustrates a flowchart of a call gapping mechanism as implemented at an originating exchange.

Exemplary embodiments of the present invention will now be described, with reference to the accompanying drawings, in which:

FIG. 5 shows a block diagram of a cellular radio communications system adapted to support the various inventive concepts of a preferred embodiment of the present invention;

FIG. 6 shows a conceptual diagram of a communication system indicating call gapping as it is employed in a preferred embodiment of the present invention;

FIG. 7 illustrates a flowchart of a call gapping mechanism for an OMC adapted to support the various inventive concepts of a preferred embodiment of the present invention;

FIG. 8 illustrates a flowchart of a call gapping mechanism for a BSS adapted to support the various inventive concepts of a preferred embodiment of the present invention;

FIG. 9 illustrates a flowchart of a call gapping mechanism for a MS adapted to support the various inventive concepts of a preferred embodiment of the present invention; and

FIG. 10 illustrates a wireless communication unit adapted in accordance with a preferred embodiment of the present invention.

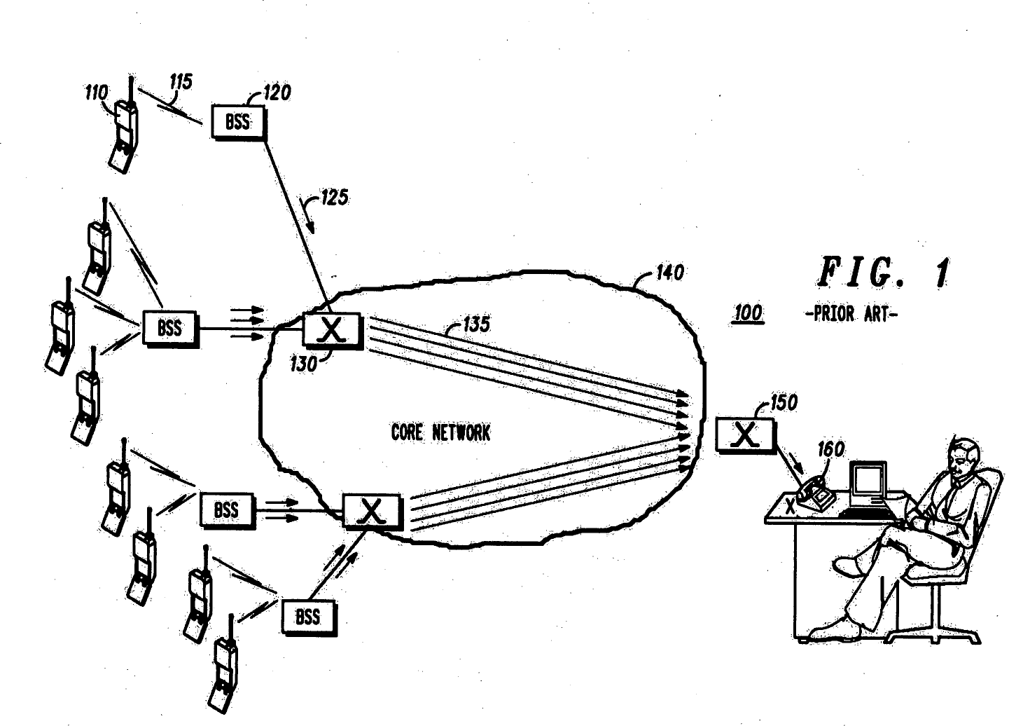

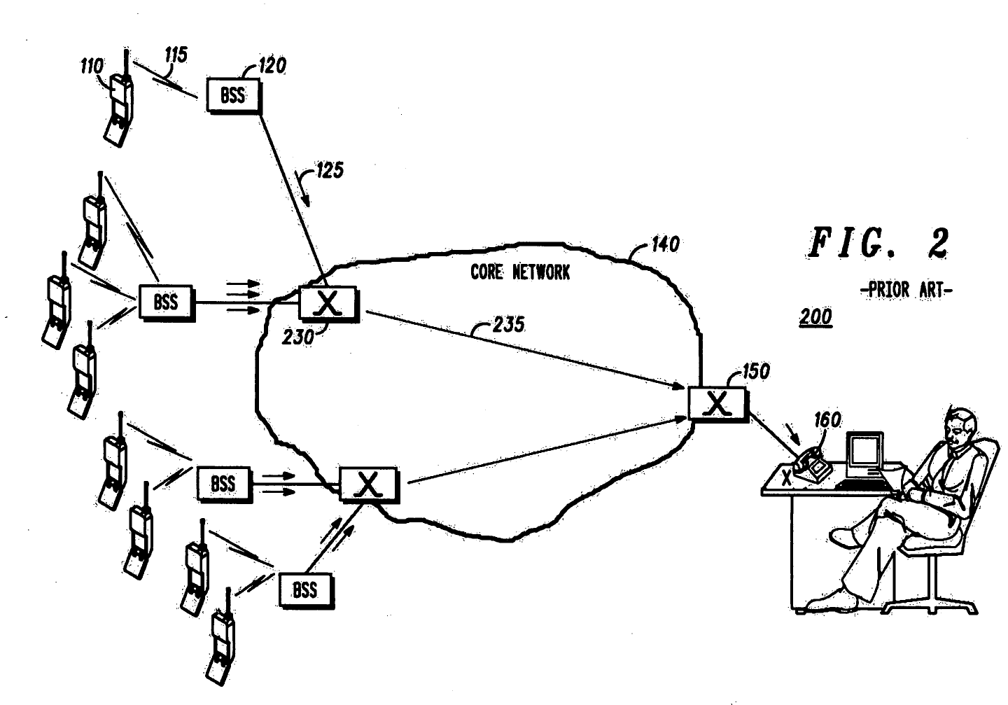

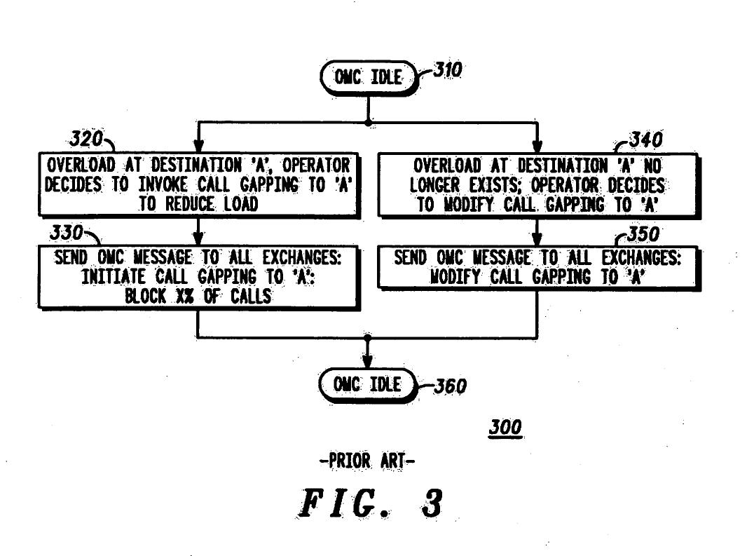

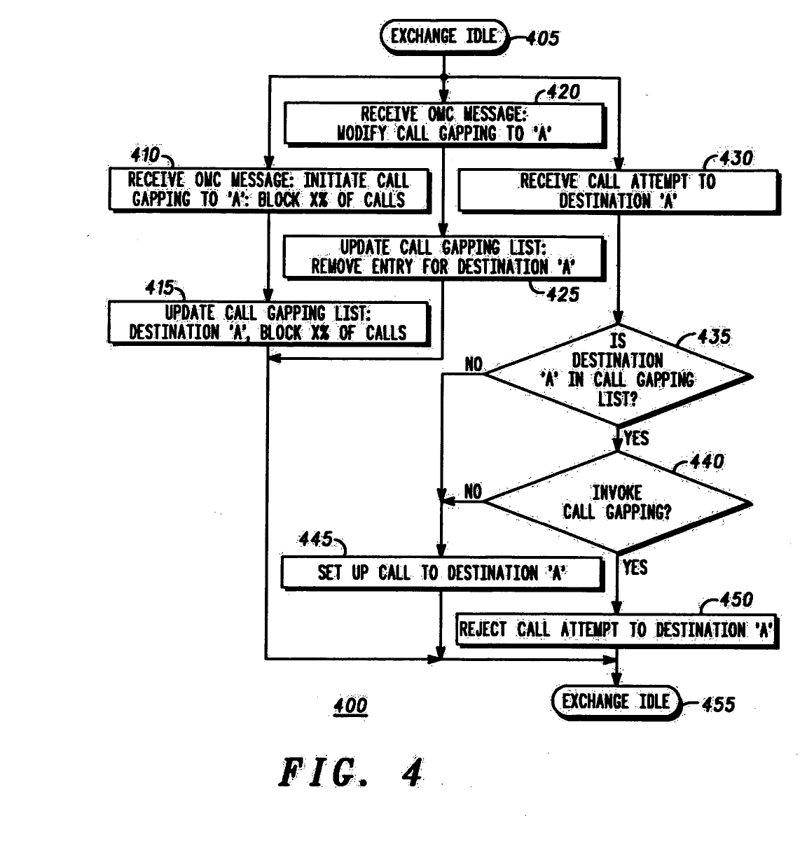

### DESCRIPTION OF PREFERRED EMBODIMENT

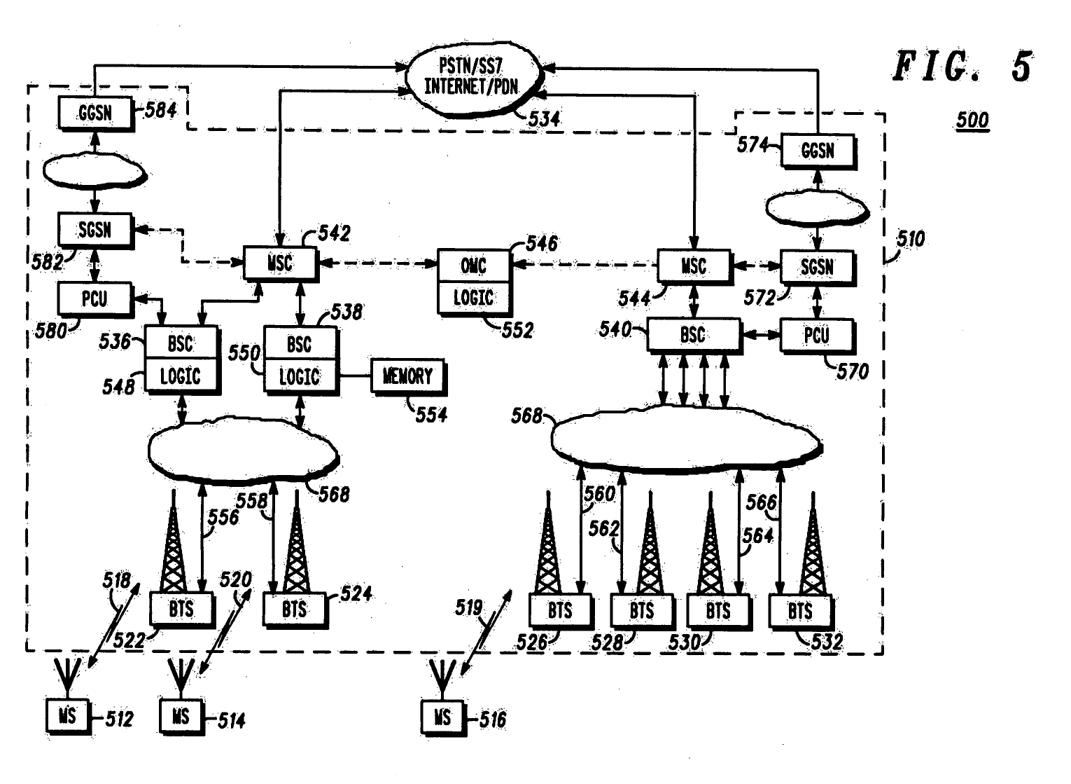

Referring first to FIG. 5, a cellular telephone communication system 500 is shown, in outline, supporting, for example, a Global System for Mobile communication (GSM) air-interface, in accordance with a preferred embodiment of the invention. The European Telecommunications Standards Institute (ETSI) has standardised the air-interface for the Global System for Mobile communication (GSM).

Generally, the air-interface protocols are administered from base transceiver sites, within the network architecture 510, which are geographically spaced apart—one base station supporting a cell (or, for example, sectors of a cell). A plurality of subscriber units hereinafter referred to as mobile stations (MSs) 512-516 communicate over the selected air-interface 518-520 with a plurality of base transceiver stations (BTS) 522-532. A limited number of MSs 512-516 and BTSs 522-532 are shown for clarity purposes only. The BTSs 522-532 may be connected to a conventional public-switched telephone network (PSTN) 534 through base station controllers (BSCs) 536-540 and mobile switching centres (MSCs) 542-544.

Each BTS 522-532 is principally designed to serve its primary cell, with each BTS 522-532 containing one or more transceiver units and communicating 556-566 with the rest of the cellular system infrastructure

Each Base Station Controller (BSC) 536-540 may control one or more BTSs 522-532, with BSCs 536-540 generally interconnected through MSCs 542-544. A BTS-BSC combination is generally referred to as a Base Switching Site (BSS). Each MSC 542-544 provides a gateway to the PSTN 534, with MSCs 542-544 interconnected through an operations and management centre (OMC) 546 that administers general control of the cellular telephone communication system 500, as will be understood by those skilled in the art.

The various system elements, such as BSCs 536-538 and OMC 546, include control logic 548, 550, 552, with the various system elements usually having an associated memory function 554 (shown only in relation to BSC 538 for the sake of clarity). A memory function of the OMC 546 typically stores historically compiled operational data as well as in-call data; call gapping blocking percentages and associated destination nodes/numbers, etc.

FIG. 5 illustrates a GSM system overlaid with a general packet radio system (GPRS) air-interface, to provide a packet data capability. In this manner, a number of packet data-capable subscriber units such as MS 512 are able to communicate via circuit-switched (CS) calls on the GSM network and packet data calls on the GPRS network. The GPRS network comprises a number of packet control units (PCUs) 570, 580 operably coupled to service GPRS support nodes (SGSNs) 572, 582 to facilitate communication from the MSS to packet data networks such as the Internet 534. The SGSNs 572, 582 (with only two being shown for clarity purposes only) are operably coupled to the GSM BSCs 536-538. The SGSNs are operably coupled to external packet data networks via GPRS gateway support nodes GGSNs 574, 584.

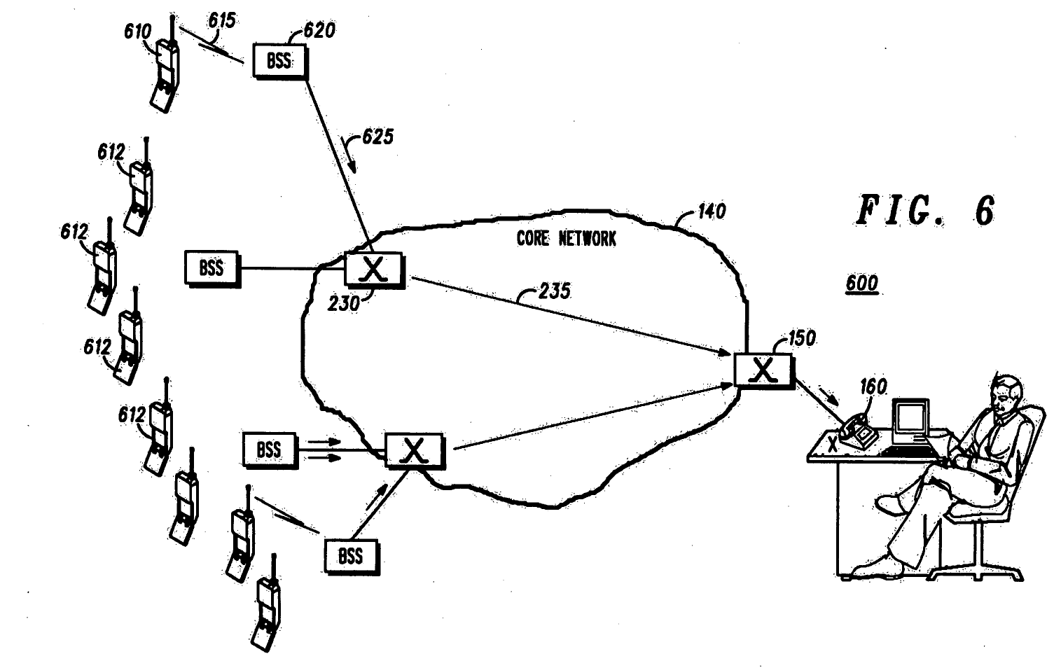

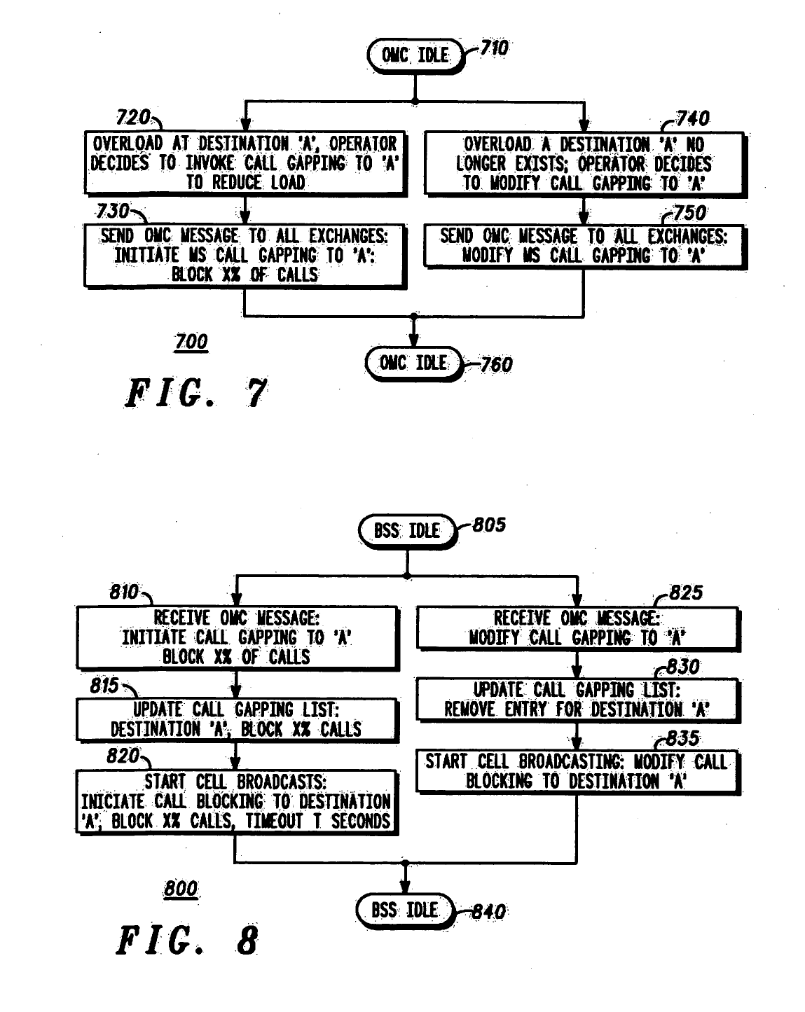

In accordance with the preferred embodiment of the present invention, the call gapping process typically implemented by the OMC and MSCs have been extended to the air-interface communication units, i.e. the BTS and MS. In particular, the air-interface communication units are adapted to invoke call gapping, rather than the originating exchange, thereby preventing wasteful use of the radio resource by blocking call attempts at source. A conceptual diagram of the modification to the call routing is illustrated in FIG. 6. The adaptation of the OMC, BTS and MS operations are illustrated in flowcharts of FIG. 7 to FIG. 9.

In general, it is envisaged that the change in call gapping operations in the OMC 546, BTS 522 and MS 512, as programmed according to the preferred embodiment of the present invention, may be implemented in a respective communication unit in any suitable manner. For example, new apparatus may be added to a conventional BTS 522 or MS 512, or alternatively existing parts of a conventional BTS 522 or MS 512 may be adapted, for example by reprogramming one or more processors therein. As such the required adaptation may be implemented in the form of processor-implementable instructions stored on a storage medium, such as a floppy disk, hard disk, programmable read only memory (PROM), random access memory (RAM) or any combination of these or other storage media.

Referring now to FIG. 6, a conceptual diagram of a cellular radio communications system 600 is illustrated, wherein the diagram indicates call gapping as it is employed in a preferred embodiment of the present invention. A particular destination node/telephone number 150 is identified as experiencing, or is anticipated to experience, an excessive amount of call attempts. Hence, call gapping is invoked for that particular destination node/telephone number 150 by, say, an OMC operably coupled to the core network 140.

In accordance with the preferred embodiment of the present invention, the OMC instructs the BSS (BSC and BTS) and respective MSs served by the BSSs to initiate a MS-based call gapping process. In this manner, a limited number of wireless subscriber units 610 attempt to contact the particular destination node/telephone number ‘X’ 160. The MSs are configured to perform a self-regulating call gapping process; in order to limit the generation and transmission of air-interface based communications. The self-regulating process ensures that only a given percentage of calls are made, with some MSs 610 successful in the self-regulating process and others, such as MSs 612 unsuccessful. The preferred mechanism to determine which MSs are successful is described later.

Hence, the air-interface resource is significantly less utilised in carrying such wireless transmissions 615 to the subscriber unit's respective BSSs 620. Advantageously, the fixed network connections 625 between the wireless BTSs and the wireless exchange 130 are also significantly less utilised in carrying such transmissions. The calls that are generated are then transmitted over the air-interface and-routed through the core network 140 to a destination exchange 150. However, notably there are much fewer calls reaching the originating exchange 130.

Fewer incoming calls are rejected by the destination exchange 150. In this manner, a large number of communication paths/routes are optimally utilised and avoid becoming congested, with many fewer attempted calls being carried on these communication paths/routes failing.

The process for setting up, and modifying, a call gapping operation in an OMC, in accordance with the preferred embodiment of the present invention, is illustrated in the flowchart 700 of FIG. 7. An Opera-ions and Management Centre (OMC) of the wireless communication system, say OMC 546 of FIG. 5, makes a determination as to how, and under what conditions, to invoke call gapping. Starting from an idle status, in step 710, the OMC (or an Operator) is informed (or recognises) that an overloaded network condition exists at a particular network node ‘A’. In response to this, the OMC invokes a call gapping process, as shown in step 720. The OMC then sends a message to all communication exchange functions (routers, gateways, etc.) to initiate a call gapping process at all MSs supported by that particular exchange.

In the preferred embodiment of the present invention, the message is sent to the MSs on the broadcast channels of the affected cells. Preferably, the message contains one or more of the following items of information, to enable the MSs to perform self-regulated call gapping:
(i) A telephone number of the overloaded exchange, for which the call gapping mechanism, is to apply;
(ii) A set or range of telephone numbers of the overloaded exchange, for which the call gapping mechanism is to apply;
(iii) A percentage number of calls that may be allowed to progress from the MS; and/or
(iv) A time duration for the call gapping mechanism to remain active.

In an enhanced embodiment of the present invention, more than one number range may be included in the broadcast message. For example, it is envisaged that a first general restriction may be applied to all numbers used that are associated with the overloaded network. Application of this first range provides, for example, a 10% call attempt rate to be used. It is envisaged that a second range may also be used, for example where the second range is specific to emergency numbers. The second range may therefore allow 100% of these calls to pass. A skilled artisan would appreciate that many alternative applications may use two or more blocking percentage values.

Furthermore, it is within the contemplation of the present invention that the aforementioned inventive concepts may be applied to call gapping using any one or more destination address(es). Thus, the inventive concepts can be applied to a single number, a list of numbers, a range of numbers (e.g. to a portion of the addresses in a particular exchange code), several ranges of numbers, etc.

Referring back to FIG. 7, in response to the message fron the OMC, the MSs are directed to initiate call gapping of ‘X %’ of calls addressed to a particular number or set of numbers, as shown in step 730. The OMC then returns to an idle mode, in step 760, until the ‘event’ has finished.

The call gapping process of the preferred embodiment therefore causes the originating an automatic reduction of ‘X’ out of ‘Y’ air-interface calls that would have been intended for that destination number. Thus, only (Y-X) out of ‘Y’ calls are actually sent from a wireless MS to its serving BTS/BSS, and ultimately onto the destination exchange via the originating exchange.

In a similar manner, the OMC (or Operator) modifies the call gapping process when it recognises that, or is informed that, the network overload/congestion situation no longer exists, as shown in step 740. When this happens, the OMC sends a message to all of the exchanges to modify the HS self-regulating call gapping process, in step 750, and returns to an idle mode of operation, in step 760.

It is envisaged that the terminology of ‘modifying’ a call blocking process, indicates that the call blocking list has been modified (e.g. an address list may have been changed), or ended (e.g. an address list is now empty).

In the preferred embodiment of the present invention, a call gapping process is in place, whereby some of the wireless calls (as perceived by the MS user) will succeed. Similarly, some attempted wireless calls will receive a “Network Busy” notification. However, advantageously, the inventive concepts described herein ensure that the call gapping process is implemented prior to any call attempts being launched into the telecommunications network. Thus, the filtering of calls is performed at source, i.e. inside the originating terminal.

Notably, the call gapping process is invoked in accordance with information supplied by the network. Referring now to FIG. 8, a flowchart 800 of the preferred call gapping mechanism of the BSS is shown, in accordance with the preferred embodiment of the present invention.

A Base switching site (BSS) of the wireless communication system, say BTS 532 and BSC 536 (forming a base switching site of FIG. 5), receives an instruction from an OMC to invoke a call gapping process. Starting from an idle status, in step 805, the BSS is informed of an overloaded/congested network condition at, say, a particular telephone number(s) or network node ‘A’. The BSS is informed that it needs to initiate a call gapping process, blocking ‘X %’ of calls to the telephone number(s) or network node ‘A’, as shown in step 810. In response to this, the BSS updates its call gapping list, as shown in step 815. The BSS then preferably broadcasts a message to all MSs supported by BSS, in step 820. The BSS then returns to an idle mode of operation, in step 840. In contrast to broadcasting a call gapping message to all supported MSs, it is envisaged that such messages may be sent to particular groups of MSs or individual MSs, in some instances, if they are identified as one or more MSs that should employ a self-regulating call gapping process.

Advantageously, the preferred embodiment of the present invention may use messaging capabilities such as short message service (SMS) messages to broadcast/communicate the call gapping requirements to all or a select number of MSs. This approach can be used to target specific users, or groups of users, where:
(i) Certain users are recognised as very heavy users and may be call gapped more frequently;
(ii) There is a ‘Denial of Service’ attack (possibly not malicious), which the Operator wants to reduce. This can be caused by erroneous auto-redial systems.
(iii) Some users receive a different grade of service (GoS) to others, and thus endure a different level of call gapping severity.

In a similar manner, the BSS modifies the call gapping process when it receives instructions from the OMC to do so, in step 825. When this happens, the BSS again updates its call gapping list by removing the entry for the particular telephone number(s) or destination node ‘A’, in step 830. The BSS then broadcasts a modify call blocking message to all of the supported MS, in step 835, and returns to an idle mode of operation, in step 840.

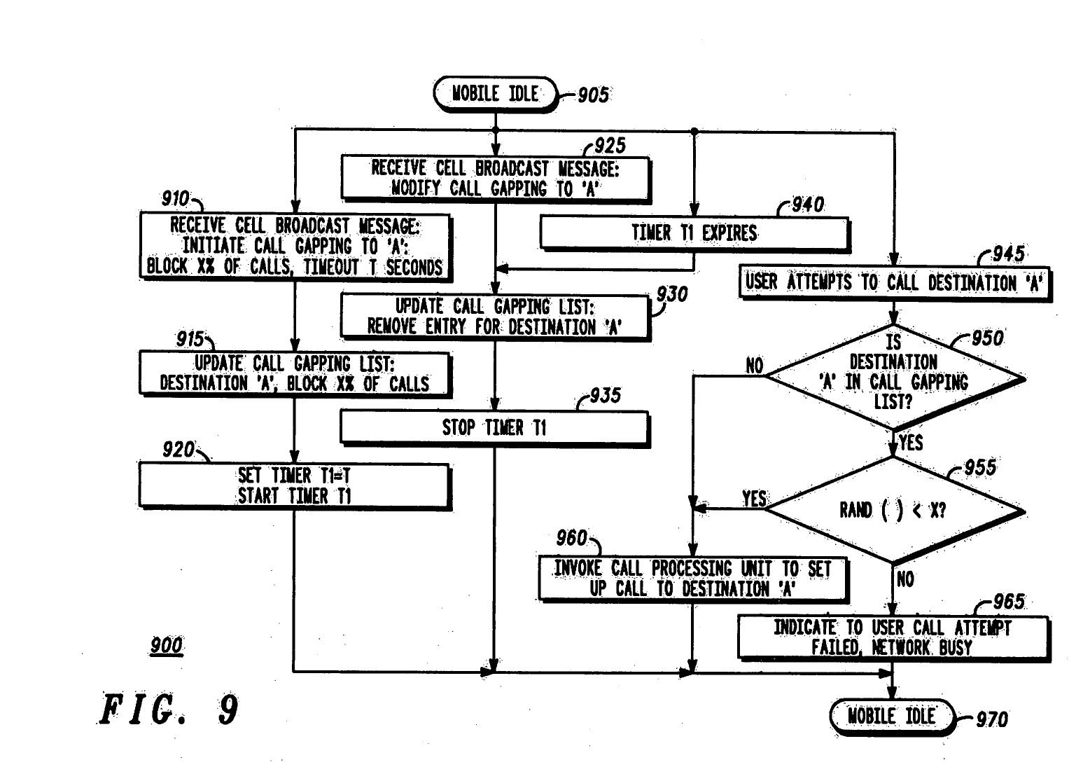

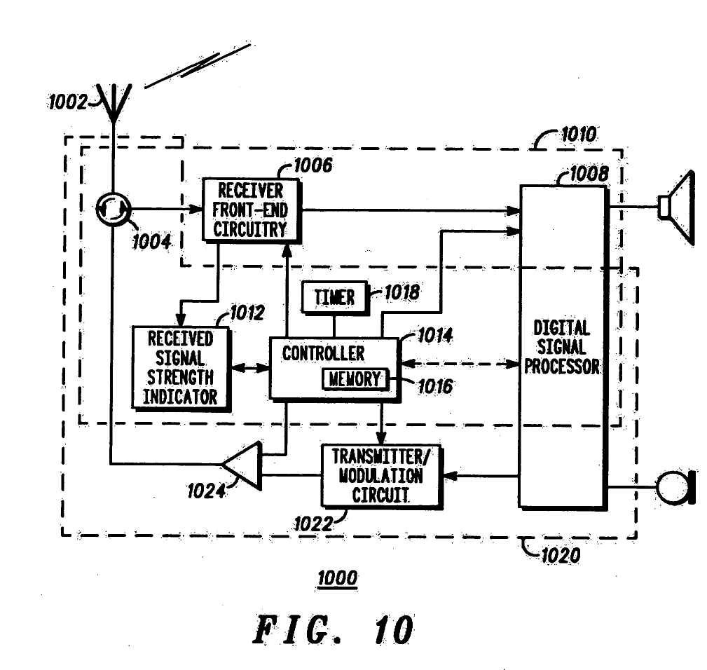

From a MS perspective, in the preferred embodiment of the present invention, the decision on whether to continue or reject a call attempt is performed internally. A skilled artisan will recognise that there are a number of mechanisms for the MS to make a decision on whether to make a requested call. A preferred mechanism is for the MS to generate a random test number and compare this number against the probability value received from the network. This process is described in the flowchart 900 of FIG. 9.

A MS starts in an idle mode of operation, as shown in step 905. The MS receives a broadcast message from its serving BSS to initiate a call gapping process, say to node ‘A’, in step 910. Preferably, the broadcast message includes a percentage of calls to be blocked. Furthermore, the broadcast message also preferably includes a time-out value ‘T’. In response to receiving the broadcast message, the MS updates its call gapping list for destination ‘A’, in step 915 and initiates a timer operation in step 920.

The MS then returns to an idle mode of operation (apart from operating the timer), with regard to the call gapping process, in step 970. If the timer ‘T1’ expires, in step 940, it is anticipated that the ‘event’ has finished. The MS also understands the ‘event’ to have finished when it receives a broadcast ‘modify call gapping message’ from its serving BSS, in step 925. In response to either of these, the MS updates its call gapping list, by removing the entry for destination ‘A’, in step 930. The timer is then stopped in step 935, before the MS returns to an idle mode of operation, in step 970.

If, whilst the call gapping process is active for a particular destination, a user attempts to make a call to the destination ‘A’, in step 945, the MS determines whether the called number is in the call gapping list, as shown in step 950. If the called number is not in the call gapping list, in step 950, the MS sets up a call, in step 960. However, if the MS determines that the called number is in the call gapping list, in step 950, a determination is made as to whether the called number should be blocked, in step 955. In this regard, the MS preferably uses a random number generator to generate, say, a value between ‘0’ and ‘1’. This value is then compared to the blocking percentage informed by the BSS. If the value exceeds the blocking percentage, the MS sets up the call as normal, in step 960. However, if this test fails, the MS returns a ‘network busy’ indication to the user, in step 965, before returninig to an idle mode of operation, in step 970. This approach takes advantage of the intelligence of cellular terminals to intelligently manage the usage of the scarce radio resources.

Although the preferred embodiment of the present invention has been described with reference to implementing a call gapping process using a random number generator arrangement, it is envisaged that any number of mechanisms could be used to implement the call attempt pass/fail decision. For example, possible mechanisms include:
(i) Using a random number generator, as described;
(ii) An MS computes a pass/fail time window; and
(iii) The network indicates the valid and/or invalid time windows as a signal (e.g. using a flag) in the call gapping broadcast messages. In this case the pass/fail opportunities are common to all mobiles in a cell.

When a MS receives the broadcast message, the MS stores and activates these restrictions, preferably for the time period indicated in this message. If this message is received again, the elapsed timer is reset to zero and starts again. Thus, it is envisaged that the network must regularly broadcast these restrictions within the expiry time period, otherwise the restrictions will be automatically removed within the MS.

It is within the contemplation of the present invention that a variety of scenarios may invoke the call gapping process hereinbefore described. For example, where a cell is overloaded or congested, perhaps following an accident in a particular geographical region, call gapping may be applied to any number of cell sites in that region. In this manner, the geographically selected call gapping process may reduce the ability of MSs to make normal calls by, say, a first percentage, and reduce a number of calls to, say, special numbers by a second another percentage. In this context, special numbers may comprise, for example, internal emergency service numbers.

Referring now to FIG. 10, there is shown a block diagram of a wireless communication unit, for example a GSM phone (MS) 1000, which is adapted to support the inventive concepts of the preferred embodiments of the present invention. As known in the art, and replicated here for completeness, the MS 1000 comprises, for example, standard radio frequency components and circuits, such as an antenna 1002 preferably coupled to an antenna switch 1004. The antenna switch 1004 provides isolation between a receiver and a transmitter chain within the MS 1000. The receiver chain typically includes receiver front-end circuitry 1006 (effectively providing reception, filtering and intermediate or base-band frequency conversion). The front-end circuitry 1006 is serially coupled to a signal processing function 1008. In accordance with the preferred embodiment of the present invention, the MS 1000 receives, interprets and adapts its operation in response to a call gapping broadcast message from the network.

In addition to processing and implementing a call gapping broadcast message, as described above with reference to the flowchart 900 of FIG. 9, the signal processing function 1008 performs all signal processing functions for the MS 1000, including, for example, demodulation, de-mapping, bit de-interleaving channel estimation and decoding, as known in the art.

For completeness, the receiver chain also includes received signal strength indicator (RSSI) circuitry 1012 coupled to the receiver front-end circuitry 1006 and the signal processing function 1008 (generally realised by a digital signal processor (DSP)). A controller 1014, also coupled to the receiver front-end circuitry 1006 and the signal processing function 1008, may therefore receive bit error rate (BER) or frame error rate (FER) data from recovered information. The controller 1014 is coupled to the memory device 1016 for storing operating regimes, such as decoding/encoding functions and the like. In accordance with the preferred embodiment of the present invention, the memory device stores a call gapping list of one or more telephone numbers or destination nodes or addresses, together with blocking percentage(s), where a call gapping process applies.

A timer 1018 is coupled to the controller 1014 to control the timing of operations (transmission or reception of time-dependent signals) with n the MS 1000. In the context of the present invention, the timer 1018 has been adapted to enable the MS to self-regulate instructed call gapping processes for a pre-defined (or instructed) period of time.

As regards the transmit chain, as also known in the art, this essentially includes an input device, such as a microphone transducer coupled in series via transmit signal processor 1008 to a transmitter/ modulation circuit 1022. Thereafter, any transmit signal is passed through a power amplifier 1024 to be radiated from the antenna 1002. The transmitter/modulation circuitry 1022 and the power amplifier 1024 are operationally responsive to the controller, with an output from the power amplifier coupled to the duplex filter or circulator 1004. The transmitter/modulation circuitry 1022 and receiver front-end circuitry 1006 comprise frequency up-conversion and frequency down-conversion functions (not. shown).

In accordance with the preferred embodiment of the present invention, the signal processor 1008 has been adapted to intercept any call attempt from the user that uses the one or more telephone numbers or destination nodes or addresses stored in the call gapping list. If the MS 1000 determined that an intercepted call attempt by the user contains one or more telephone numbers or destination nodes or addresses from the stored call gapping list, the signal processor 1008 decides whether to accept or reject the call request.

The signal processor 1008 has been further adapted to include (or be operably coupled to) a random number generator. The random number generator is preferably invoked when a user attempts to call a partially blocked (call gapping) address/number/node. If, for example after comparing a random number generated with a blocking percentage received in a broadcast message and stored in the memory device, the signal processor 1008 determined that a call is allowed, the MS 1000 processes the call in the normal manner. Otherwise, the MS 1000 preferably sends a ‘network busy’ message to the display of the MS 1000 and does not thereafter generate a wireless transmission.

Of course, the various components within the MS 1000 can be arranged in any suitable functional topology that is able to utilise the inventive concepts of the present invention. Furthermore, the various components within the MS 1000 can be realised in discrete or integrated component form, with an ultimate structure therefore being selected based on the MS designer.

In contrast to a random number generated approach, it is envisaged that an alternative mechanism to implement call gapping may be to count out a number of successful call attempts, followed by a number of unsuccessful attempts (i.e. set an integer OK/Fail ratio).

With the evolution towards third (and beyond) generation cellular communication units, the wireless subscriber units (MSs) are becoming ever mote complex and proficient. For example, it is envisaged that the inventive concepts described herein are ideally suited to a Mobile Execution Environment (MEXE) application, whereby the functionality to perform such MS call gapping is downloaded over-the-air into the MS (perhaps written in Java™).

In the preferred embodiment of the present invention, it is envisaged that a list of destination numbers, each with blocking probability associated with it may be broadcast from the network. In this regard, it is envisaged that each entry could be a complete number. Alternatively, the destination nodes/numbers may be based on wildcards, which indicate one or more numbers that are ignored when performing the comparison against the user-input address.

Although the invention has been described with reference to a speech communication air-interface such as GSM, it is within the contemplation of the invention that the inventive concepts herein described are equally applicable to any wireless communication system. It is also envisaged that, when applied to a GPRS (or other packet data communication systen such as a Universal Mobile Telecommunication System (UMTS)), that the use of alternative addressing mechanisms could benefit from the inventive concepts described herein. For example, IP addresses, or domain name server (DNS) addresses could be used in a data-networking scenario.

Although the preferred embodiment of the present invention has been described with reference to implementation in a wireless communication unit capable of functioning in a GSM, GPRS, UMTS, IS-95 or CDMA2000 wireless communication system, it is envisaged that the inventive concepts can be applied in a fixed communication unit, such as a Personal computer employing voice over Internet Protocol. It is also within the contemplation of the invention that the call gapping process can be applied to control other procedures. For example, the inventive concepts could be applied to any data connections by, say, gapping PDP context activation requests (to reduce signalling load), attaches, mobility management procedures, etc.

It will be understood that the wireless communication system, wireless communication unit and method for congestion relief, as described above, tends to provide at least one or more of the following advantages:
(i) Congestion relief using a call gapping technique can be extended to minimise air-interface traffic in-a wireless communication environment to prevent calls being initiated that would ultimately result in an unconnected call.
(ii) The proposed congestion relief mechanism reduces needless traffic between a BSS and a local (originating) exchange, thereby making that resource available for communications that have a chance of being successful.
(iii) The inventive concepts can be applied to any address-based scenario.
(iv) Specific call gapping targeted to mobiles-to control, say, a ‘Denial of Service’ attack.

Whilst specific, and preferred, implementations of the present invention are described above, it is clear that one skilled in the art could readily apply variations and modifications of such inventive concepts.

Thus, a wireless communication system, a wireless communication unit and a method for reducing congestion have been provided, wherein the aforementioned disadvantages associated with prior art arrangements have been substantially alleviated.

1. A wireless communication system comprising:
a plurality of communication resources;
a plurality of mobile stations utilizing the communication resources, wherein at least one of the plurality of mobile stations is configured to employ a call gapping process; and
a plurality of communication paths for routing a communication initiated by one of said plurality of mobile stations to a destination node.

2. The wireless communication system according to claim 1, wherein said call gapping process employed by said at least one of said plurality of mobile stations is performed prior to normal communication, preventing a call that would likely be unsuccessful from being initiated and sent from said mobile station.

3. The wireless communication system according to claim 2, wherein following a requested call being prevented from accessing the wireless communication system, an indication is provided to a user that the communication system is busy.

4. The wireless communication system according to claim 1, wherein said communication system further comprises a communication device that determines when one or more address or destination node is overloaded, and in response to such a determination the communication device instructs the plurality of mobile stations to initiate a self-regulating call gapping process for said one or more address or destination node.

5. The wireless communication system according to claim 1, wherein said at least one of said plurality of mobile stations is sent a wireless message containing at least one call gapping instruction.

6. The wireless communication system according to claim 5, wherein said at least one call gapping instruction is selected from one of the group of:
(i) One or more address of a destination node;
(ii) One or more telephone numbers;
(iii) One or more call blocking rate; and
(iv) A time-out value.

7. The wireless communication system according to claim 1, wherein said wireless communication system is one of a GSM, GPRS, or UMTS, IS-95, and CDMA2000 communication system, and a personal computer employing voice over Internet Protocol.

8-12. (canceled)

13. A method of congestion relief in a wireless communication system, the method comprising the steps of:
invoking a call gapping mode of operation; and
performing said call gapping process in a wireless communication unit operating in said wireless communication system.

14. The method of congestion relief in a wireless communication system according to claim 13, further comprising the step of:
indicating to a user that the communication system is busy following a requested call being prevented from accessing the wireless communication system.

15. The method of congestion relief in a wireless communication system according to claim 13, the method further comprising the steps of:
determining when one or more address or destination node is overloaded; and
instructing a plurality of mobile stations to initiate a self-regulating call gapping process for said one or more address or destination node, in response to such a determination.

16. The method of congestion relief in a wireless communication system according to claims 13, further comprising the step of sending a wireless message to at least one of a plurality of mobile stations, wherein said message contains at least one call gapping instruction.

17. The method of congestion relief in a wireless communication system according to claims 16, wherein said message contains at least one call gapping instruction selected from the group of:
(i) One or more address of a destination node;
(ii) One or more telephone numbers;
(iii) One or more call blocking rate; and
(iv) A time-out value.

18. (canceled)
